(19) United States
(12) Patent Application Publication
(10) Pub. No.: US 2026/0236532 A1
(43) Pub. Date: Aug. 13, 2026

(54) COMPUTING DEVICE AND APPROXIMATE NEAREST NEIGHBOR SEARCH METHOD

(71) Applicant: MACRONIX INTERNATIONAL CO., LTD., Hsinchu (TW)

(72) Inventors: Steven Yenhee CHENG, White Plains, NY (US); Chiao-Wen YEH, New Taipei City (TW); Hsiang-Lan LUNG, Kaohsiung City (TW)

(21) Appl. No.: 19/050,156

(22) Filed: Feb. 11, 2025

(51) Int. Cl. G06F 16/901

(52) U.S. Cl. CPC G06F 16/9024

(57) ABSTRACT

An ANNs method is provided by an aspect of the present disclosure. The ANNs method includes: enabling a memory loading a k-means tree corresponding to vectors; sequentially obtaining a node, with the shortest distance from the query vector, among one or more nodes of each level from a root level to a leaf level of the k-means tree, until result node in the leaf level is obtained; enabling the memory loading a RNG, corresponding to the result node, among one or more RNGs stored in a storage device; obtaining a nearest vector cluster, with the shortest distance from the query vector, among vector clusters in the RNG, and enabling the memory loading a nearest posting list content, corresponding to nearest vector cluster, among posting list contents stored in the storage device; using vector data, of the vectors, in the nearest posting list content as query result and outputting it.

### TECHNICAL FIELD

The present disclosure relates in general to techniques of computing device for approximate nearest neighbor search (ANNs), and more particularly, to approximate nearest neighbor search method.

### BACKGROUND

Nowadays, for large language models (LLMs), retrieval augmented generation (RAG) are conducted for vector search, such as approximate nearest neighbor search (ANNS), among different types of reference datasets to generate more accurate answers based on these reference datasets. Using pre-built indices, corresponding to datasets, for vector search, will use large amounts of fast memory, such as random access memory (RAM), which will also increase the costs of hardware. Thus there are needs for techniques of decreasing memory usage during vector search.

### SUMMARY

A system of one or more computers is configurable to perform particular operations and/or actions by virtue of having software, firmware, hardware, or a combination thereof installed on the system that in operation cause the system to perform and/or control the operations and/or actions. One or more computer programs are configurable to perform particular operations and/or actions by virtue of including instructions that, when executed by data processing apparatus, cause the apparatus to perform the operations and/or actions.

The first aspect of the present disclosure features a computing device for approximate nearest neighbor search (ANNs). The computing device includes a processor. The computing device also includes a memory for loading a k-means tree index. The k-means tree index includes multiple levels, from a root level to a leaf level, and each of the multiple levels includes one or more nodes. The computing device also includes a storage device, coupled to the processor and the memory, and configured to store one or more relative neighborhood graphs (RNGs) corresponding to the one or more nodes of the leaf level of the k-means tree index, and store multiple posting list contents of multiple vector clusters in each of the one or more RNGs. When the processor executes the ANNs, the processor executes: receiving a search instruction including a query vector; obtaining a node, with the shortest distance from the query vector, among the one or more nodes of each of the multiple levels, from the root level to the leaf level of the k-means tree, sequentially, until a result node in the leaf level is obtained; enabling the memory loading a RNG, corresponding to the result node, of the one or more RNGs from the storage device; obtaining a nearest vector cluster, from the multiple vector clusters, with the shortest distance from the query vector; enabling the memory loading a nearest posting list content, corresponding to the nearest vector cluster, of the multiple posting list contents from the storage device; and using multiple full-precision vector contents of the multiple vectors in the nearest posting list content as a query result and outputting the query result. Other embodiments of this aspect include corresponding computer systems, apparatus, and computer programs recorded on one or more computer storage devices, each configured to perform the actions of the methods.

The second aspect of the present disclosure features an ANNs method, for a computing device including a processor, a memory and a storage device. The ANNs method includes enabling, by the processor, the memory loading a k-means tree index. The k-means tree index is corresponding to multiple vectors. The ANNs method also includes obtaining, by the processor, a node, with the shortest distance from a query vector, among one or more nodes of each of multiple levels, from a root level to a leaf level of the k-means tree, sequentially, until a result node in the leaf level is obtained. The ANNs method also includes enabling, by the processor, the memory loading a RNG, corresponding to the result node, of one or more RNGs storing in the storage device. The ANNs method also includes obtaining, by the processor, a nearest vector cluster, from multiple vector clusters, with the shortest distance from the query vector, and enabling the memory loading a nearest posting list content, corresponding to the nearest vector cluster, of multiple posting list contents storing in the storage device. The ANNs method also includes using multiple full-precision vector contents of the multiple vectors in the nearest posting list content as a query result and outputting the query result. The one or more RNGs are respectively corresponding to the one or more nodes in the leaf level, and the multiple posting list contents are respectively corresponding to the multiple vector clusters in each of the one or more RNGs. Other embodiments of this aspect include corresponding computer systems, apparatus, and computer programs recorded on one or more computer storage devices, each configured to perform the actions of the methods.

The third aspect of the present disclosure features a computing device for ANNs. The computing device includes a processor, configured to process multiple vectors and generate a space partitioning data. The space partitioning data includes a k-means tree index, corresponding to the multiple vectors and including multiple levels, from a root level to a leaf level, wherein each of the multiple levels includes one or more nodes. The space partitioning data also includes one or more RNGs, corresponding to the one or more nodes of the leaf level of the k-means tree, each of the one or more RNGs including multiple vector clusters. The space partitioning data also includes multiple posting list contents, corresponding to the multiple vector clusters in each of the one or more RNGs. The computing device also includes a memory, configured to load the k-means tree. The computing device also includes a storage device, configured to store the one or more RNGs and the multiple posting list contents. When the processor executes the ANNs, the processor executes: receiving a search instruction including a query vector; obtaining a node, with the shortest distance from the query vector, among the one or more nodes of each of the multiple levels, from the root level to the leaf level of the k-means tree, sequentially, until a result node in the leaf level is obtained; enabling the memory loading a RNG, corresponding to the result node, of the one or more RNGs from the storage device; obtaining a nearest vector cluster, from the multiple vector clusters, with the shortest distance from the query vector; enabling the memory loading a nearest posting list content, corresponding to the nearest vector cluster, of the multiple posting list contents from the storage device; and using multiple full-precision vector contents of the multiple vectors in the nearest posting list content as a query result and outputting the query result. Other embodiments of this aspect include corresponding computer systems, apparatus, and computer programs recorded on one or more computer storage devices, each configured to perform the actions of the methods.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a diagram illustrating an example computing device, according to some implementations of the present disclosure.

FIG. 2 is a diagram illustrating the K-means tree index and the respective RNG and the respective vector cluster, according to some implementations of the present disclosure.

FIG. 3 is a diagram illustrating the centroid block list of the vector cluster in the RNG, and the content of the posting list content, according to some implementations of the present disclosure.

FIGS. 4A to 4C are diagrams respectively illustrating data, for query operation, accessed by the memory during different stages, according to some implementations of the present disclosure.

FIG. 5 is a flowchart illustrating a procedure of ANNs for the computing device, according to some implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

One or more flow diagrams are described herein. Processing described by the flow diagrams is implementable and/or directable using processors programmed using computer programs stored in memory accessible to computer systems and executable by the processors, using dedicated logic hardware (including field programmable integrated circuits), and using various combinations thereof. Various actions are combinable, performable in parallel, and/or performable in a different sequence without affecting processing achieved. In some cases, a rearrangement of actions achieves identical results only if certain other changes are made as well. In other cases, a rearrangement of actions achieves identical results only if certain conditions are satisfied. Furthermore, for clarity, some of the flow diagrams herein omit certain some actions not necessary for understanding the disclosed techniques. Various additional actions are performable before, after, and/or between the illustrated actions.

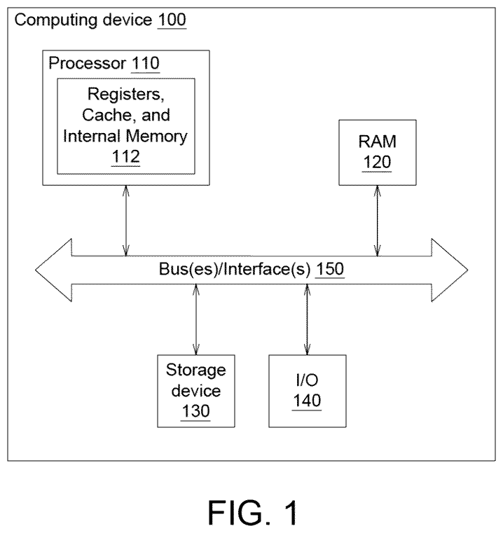

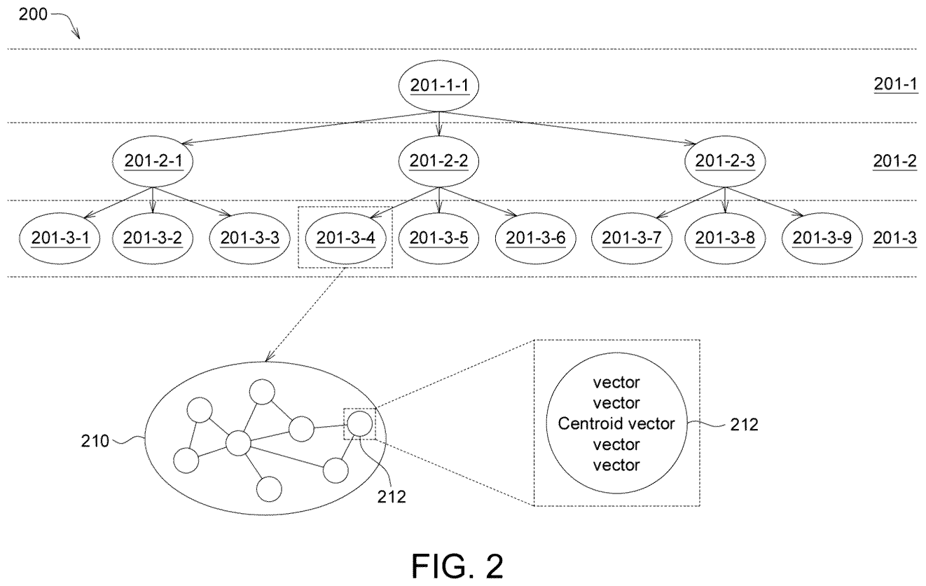

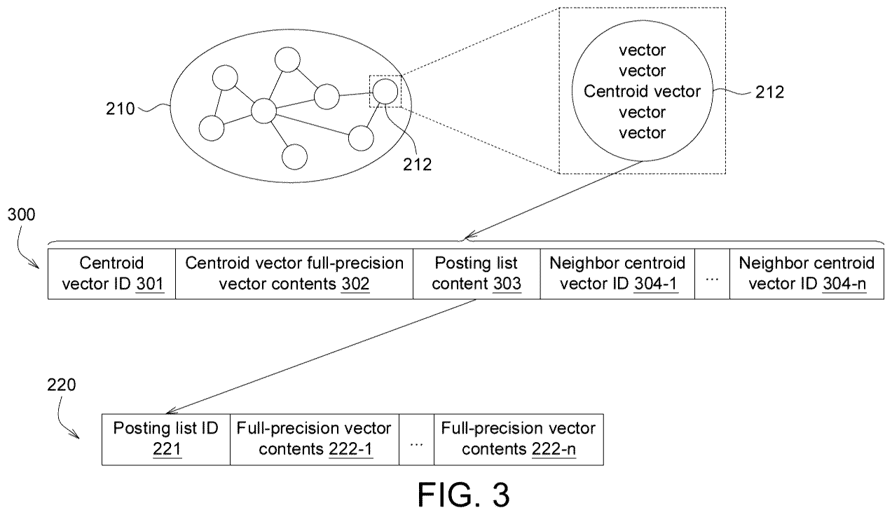

FIG. 1 is a diagram illustrating an example computing device 100, according to some implementations of the present disclosure, FIG. 2 is a diagram illustrating the K-means tree index 200 and the respective RNG 210 and the respective vector cluster 212, according to some implementations of the present disclosure, and FIG. 3 is a diagram illustrating the centroid block list 300 of the vector cluster 212 in the RNG 210, and the content of the posting list content 220, according to some implementations of the present disclosure.

Referring to the FIGS. 1 to 3, the computing device 100 includes the processor 110, the RAM 120, the storage device 130 and I/O 140 that are coupled by Bus(es) /Interface(s) 150.

The CPU 110 includes one or more processing units, such as any combination of hardware units enabled to execute programmed instructions, microprocessors, signal processors, graphic processors, AI processors, and the like. One or more of the processing units optionally include one or more internal registers (some of which are optionally architecturally visible), one or more cache memories, and/or one or more internal memories (such as relating to buffering and/or coalescing), as represented by Registers, Cache, and Internal Memory 112. In some implementations, the processor 110 can process multiple vectors of mass datasets, and generate space partition data according to the multiple vectors. The space partition data includes index generated according to vectors of mass datasets, such as the K-means tree index 200 of FIG. 2. The K-means tree index is generated by using space partition tree and graph, SPTAG, algorithm of Microsoft. The K-means tree index includes multiple levels, from the root level to the leaf level. Each level includes different amount of nodes. For the example of FIG. 2, the K-means tree index 200 includes three levels, from the root level 201-1 to the leaf level 201-3, which the root level 201-1 includes the node 201-1-1, the second level 201-2 includes nodes 201-2-1 to 201-2-3, and the leaf level 201-3 includes nodes 201-3-1 to 201-3-9, but not limited to. As shown by FIG. 2, from the root level 201-1 to the leaf level 201-3, each node in each level (excepting the leaf level) includes one or more node respectively in the lower level. The space partition data also includes multiple relative neighborhood graphs, RNGs, corresponding to multiple nodes in the leaf level of the K-means tree index, such as the RNG 210 corresponding to the node 201-3-4 in the leaf level 201-3 of the K-means tree index 200, as shown by FIG. 2. Each RNG includes multiple vector clusters, which means each vector cluster includes part of the multiple vectors in the mass datasets, such as the vector cluster 212 of FIG. 2. The space partition data also includes posting list contents corresponding to each vector cluster, such as posting list content 220 of FIG. 3. Each posting list content includes respective data of foresaid part of multiple vectors in each vector cluster. In some implementations, after generating the space partition data, the processor 110 can instruct the RAM 120 to load the K-means tree index (such as the K-means tree index 200), and instruct the storage device 130 to store multiple RNGs corresponding to the leaf level of the K-means tree, and multiple posting list contents.

The RAM 120 includes one or more DRAM device for storage of instructions and/or data in greater quantities than storage internal to the processor 110. RAM 120 can be used for loading the K-means tree index (such as the K-means tree index 200) for vector search (such as ANNs), and, by the instruction of the processor 110, loading required data during the vector search (such as ANNs), such as respective one of multiple RNGs and posting list contents stored in the storage device 130.

The storage device 130 includes one or more storage elements, such as flash-based storage elements of a SSD, or rotation-based magnetic and/or optical non-volatile storage elements (e.g., disks) of HDD, for storage of instructions and/or data. SDD is optionally accessible with reduced latency compared to HDD. The cost of per storage unit of the storage device 130 is less than that of RAM 120. As discussed above, the techniques provided by implementations according to the present disclosure, can store RNGs and posting list contents in the storage device 130, without pre-loading all RNGs into the RAM 120, which the usage of the RAM 120 can be decreased. In some implementations, RNGs is stored, as data segment forms, in fixed blocks of the storage device 130, such as the centroid block list 300 of the vector cluster 212 in the RNG 210. The centroid block list of each vector cluster of RNG includes the centroid vector ID (identifier or identification) of each vector cluster in the RNG, the centroid victor full-precision vector contents, the posting list content of the vector cluster and the neighbor centroid vector ID of each neighbor vector cluster, such as the centroid block list 300 of the vector cluster 212 in the RNG 210 includes the centroid vector ID 301 of the vector cluster 212, the centroid victor full-precision vector contents 302, the posting list content 303 of the vector cluster 212 and the neighbor centroid vector ID (neighbor centroid IDs 304-1 to ID 304-n) of each neighbor vector cluster. The data of the posting list content 303 stored in the storage device 130 includes the posting list ID for full-precision vector contents of all vectors included by the respective vector cluster in a posting list, or includes the posting list ID and full-precision vector contents of all vectors included by the respective vector cluster. Such as the posting list content 220 corresponding to the posting list content 303 of the centroid block list 300, includes the posting list ID 221 and full-precision vector contents (full-precision vector contents 222-1 to 222-n) of all vectors included by the vector cluster 212.

The I/O 140 includes elements to interface any combination of the processor 110, the RAM 120 and/or the storage device 130 to elements external to the computing device 100. Example external elements include mass storage devices, local and wide-area networks (such as the Internet), human interface components (such as keyboards, mice, and/or monitors), and other elements providing capabilities to extend and/or augment capabilities not otherwise provided by the computing device 100. In some implementations, I/O 140 can be used for receiving search instruction including query vector, or outputting query result, of vector search (such as ANNs), generated by the processor 110.

The Bus(es)/Interface(s) 150 enables communication between the elements coupled to it (e.g., the processor 110, the RAM 120, the storage device 130 and/or the I/O 140). The Bus(es)/Interface(s) 150 variously includes one or more serial and/or parallel communication channels as well as optional protocol conversion and/or adaptation capabilities to facilitate communication between the elements coupled to it.

Other partitionings of elements, coupling between elements, and capabilities and/or capacities of elements illustrated in the figure are contemplated, as well as additional elements, according to usage requirements.

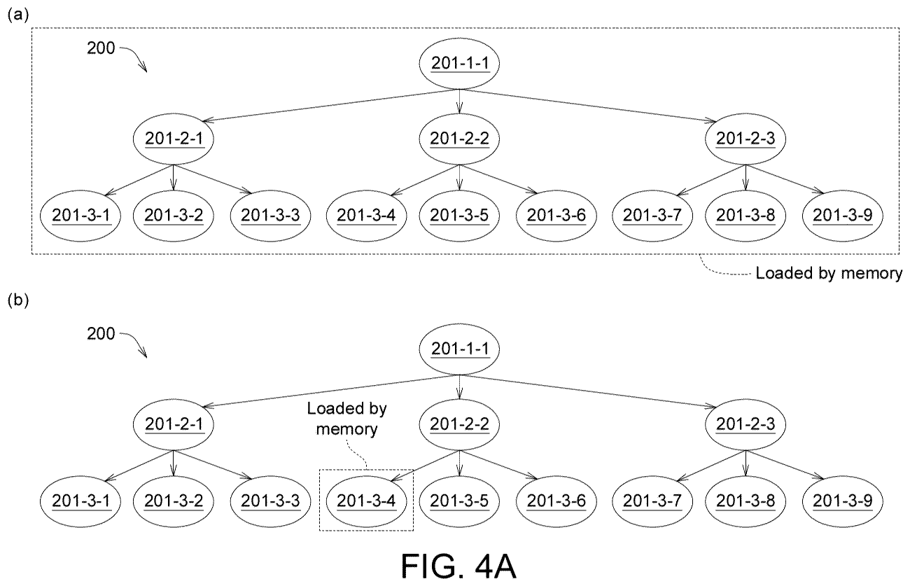

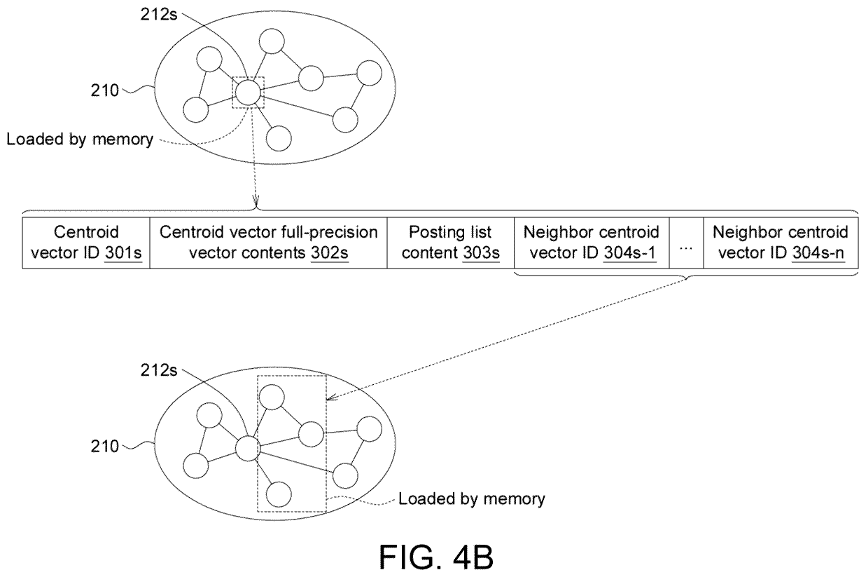

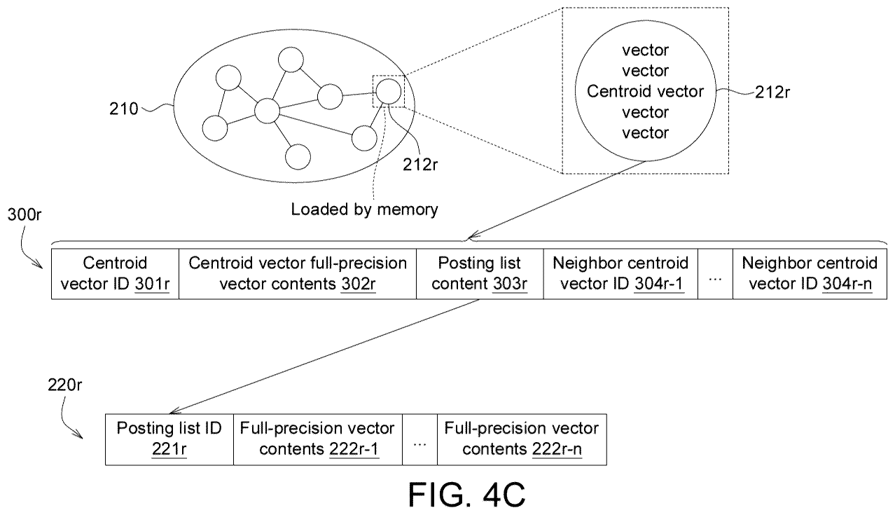

During vector search (such as ANNs), only the required data will be loaded into memory, such as RAM 120. When the query operations access each level of the K-means tree, such as K-means tree index 200, the k-means tree index (or certain block of the k-means tree index), respective RNG and/or respective posting list content is/are sequentially loaded into memory, such as RAM 120. In other words, only the required data for the query operations are retained in the memory, and the data not required anymore can be removed, such as by the instruction of processor 110, from the memory, which can decrease the usage of memory. For example, when the query operation accesses the node 201-2-2 of the second level 201-2 of the K-means tree index 200, only the node 201-2-2 of the second level 201-2 of the K-means tree index 200, and the respective block of nodes 201-3-4 to 201-3-6, in the leaf level 201-3, corresponding to the node 201-2-2, are retained in the memory 120, which other part of the K-mean tree index can be removed from the memory 200. The query operation based on the computing device of FIG. 1, the K-means tree index 200 of FIG. 2, and the centroid block list 300 and the posting list content 220 of FIG. 3, will be detailed described referring to FIG. 4 as follows.

FIGS. 4A to 4C are diagrams respectively illustrating data, for query operation, accessed by the memory (such as the RAM 120 of FIG. 1) during different stages, according to some implementations of the present disclosure. As shown by schema (a) of FIG. 4A, when receives search instruction with query vector, the processor may enable memory to load all the K-means tree index 200, to search nodes, with the shortest distance from the query vector, of each lower level sequentially from the node 201-1-1 of the root level (the top level). In this case, the node, with the shortest distance from the query vector, of the second level, is the node 201-2-2, and the node, with the shortest distance from the query vector, of the leaf level (the bottom level), is the node 201-3-4 as a result node, as shown by schema (b) of FIG. 4A. It also means that, after the result node (the node 201-3-4) is determined, other data of the K-means tree index 200 (excepting the node 201-3-4) can be removed from the memory, to save memory usage. In some implementations, when the node with the shortest distance from the query vector is obtained at each level, only the data of this node and its lower-level associated nodes in the K-means tree index can be retained in the memory, and other data of the K-means tree index can be removed from the memory. For example, when the node 201-2-2 with the shortest distance from the query vector is obtained at the second level, only the node 201-2-2 and the lower-level associated nodes 201-3-4 to 201-3-6, in the K-means tree index 200, are retained in the memory, and other data of the K-means tree index 200 can be removed from the memory. Accordingly, adjusting data loaded into the memory during different stages, can effectively save the usage of fast memory. In some implementations, the search command also includes the maximum size of the candidate list and the result size k, which can be used to adjust the output of query results, wherein k is a positive integer greater than or equal to one.

After the result node (the node 201-3-4) is determined, the processor may enable the memory loading the RNG corresponding to the result node (the node 201-3-4). As discussed above, by the techniques provided by implementations according to the present disclosure, RNGs are stored in the storage device by forms of data segment, as centroid block lists (such as the centroid block list 300 of FIG. 3). A starting vector cluster can be set among multiple vector clusters included in each RNG as a starting point for comparing the distance between the query vector and the multiple vector clusters included in the RNG. Referring to FIG. 4B, in this case, after the result node (the node 201-3-4) is determined, the processor may enable the memory loading, such as loading to a priority queue in the memory, only the starting centroid block list 300s of the starting vector cluster 212s in the RNG 210 corresponding to the result node (the node 201-3-4), which can also save usage of the memory. The starting centroid block list 300s includes a centroid vector full-precision vector contents 302s of the starting vector cluster 212s, and centroid vector IDs (neighbor centroid vector IDs 304s-1 to 304s-n) of the neighbor vector clusters adjacent to the starting vector cluster 212s. By such data, the relevant centroid block lists of these neighbor vector clusters can be continuously obtained (as neighbor checks), such as loading into the save queue in the memory, and centroid vector full-precision vector contents of each centroid block list can be used to obtain a neighbor vector cluster with the shortest distance from the query vector among these neighbor vector clusters. In some implementations, after obtaining multiple centroid block lists corresponding to multiple neighbor vector clusters according to the starting centroid block list 300s (completing neighbor checks), the starting centroid block list 300s of the starting vector cluster 212s can be removed from the priority queue of the memory and marked as checked, as shown by the lower part of FIG. 4B.

After obtaining the neighbor vector cluster, with the shortest distance from the query vector, among these neighbor vector clusters, the neighbor vector cluster can be set as a starting vector cluster and the above operations can repeat until the nearest vector cluster 212r, with the shortest distance from the query vector, in the RNG 210 is obtained, as shown by FIG. 4C. In some implementations, by each time, when a neighbor vector cluster is set as a starting vector cluster, which leads the centroid block list (being used a starting centroid block list) corresponding to the neighbor vector cluster to be loaded into the priority queue in the memory, multiple full-precision vector contents in the posting list content corresponding to the neighbor vector cluster can be loaded, from the storage device, into the candidate list in the memory, as candidates for the query result, such as when the neighbor vector cluster is already with the shortest distance from the query vector as the nearest vector cluster in the RNG. During this search process, full-precision vector contents continue to accumulate in the candidate list. When the data amount of full-precision vector contents is accumulated to be greater than the maximum size of the candidate list of the search instruction, full-precision vector contents with longer distance from the query vector can be removed from the candidate list in the memory.

Referring to FIG. 4C, after the nearest vector cluster 212r, with the shortest distance from the query vector, in the RNG 210 is determined, the processor may enable the memory to load, from the storage device, the result centroid block list 300r corresponding to the nearest vector cluster 212r, and load, from the storage device, the nearest posting list content 220r according to the posting list content 303r in the result centroid block list 300r. The full-precision vector contents 220r-1 to 220r-n of the nearest posting list content 220r can be also added to the candidate list in the memory. At the final stage, based on the result size k, the processor can select k full-precision vector contents nearest to the query vector from the candidate list as query results and output the query results.

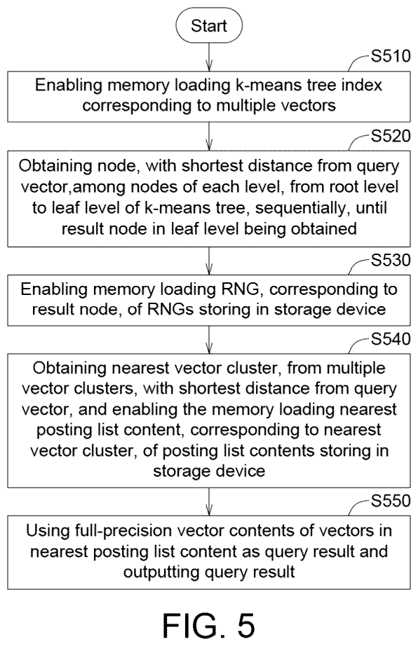

FIG. 5 is a flowchart illustrating a procedure of ANNs for the computing device, according to some implementations of the present disclosure. In step S510, a processor for example, enables a memory loading a k-means tree index corresponding to multiple vectors.

In step S520, the processor for example, sequentially obtains a node, with the shortest distance from the query vector, among one or more nodes of each level from a root level to a leaf level of the k-means tree, until a result node in the leaf level is obtained.

In step S530, the processor for example, enables the memory loading a RNG, corresponding to the result node, among one or more RNGs stored in a storage device.

In step S540, the processor for example, obtains a nearest vector cluster, with the shortest distance from the query vector, among multiple vector clusters in the RNG, and enables the memory loading a nearest posting list content, corresponding to nearest vector cluster, among multiple posting list contents stored in the storage device.

In step S550, the processor for example, uses vector data, of the multiple vectors, in the nearest posting list content as query result and outputting it.

In certain configurations, each of the one or more RNGs are stored in the storage as forms of multiple centroid block lists, and each of the multiple centroid block lists respectively includes a centroid vector ID corresponding to each of the multiple vector clusters in each of the one or more RNGs, a centroid vector full-precision vector content, a respective one of the plurality of posting list contents, and multiple neighbor centroid vector IDs. The respective one of the plurality of posting list contents includes a posting list ID and multiple full-precision vector contents of multiple vectors included by one of the multiple vector clusters corresponding to the respective one of the plurality of posting list contents, or includes the posting list ID of a posting list including the plurality of full-precision vector contents.

In certain configurations, the multiple vectors included by each of the multiple vector clusters of each of the one or more RNGs, are a centroid vector and multiple neighbor vectors, and the centroid vector is used for calculating the distance between the query vector and each of the multiple vector clusters. The centroid vector of each of the multiple vector clusters is related to a respective one of the multiple centroid block lists.

In certain configurations, the multiple vector clusters in each of the one or more RNGs includes a starting vector cluster, and one or more neighbor vector clusters couple to the starting vector cluster. The processor obtaining the nearest vector cluster, from the multiple vector clusters, with the shortest distance from the query vector, includes: obtaining a neighbor vector cluster, with the shortest distance from the query vector, from the one or more neighbor vector clusters according to a starting centroid block list, corresponding to the starting vector cluster, of the multiple centroid block lists; enabling the memory loading a posting list content, corresponding to the neighbor vector cluster, of the multiple posting list contents from the storage device; and setting the neighbor vector cluster as the starting vector cluster and repeating the foresaid operations, until obtaining the nearest the nearest vector cluster, with the shortest distance from the query vector, in the RNG.

In certain configurations, the processor obtaining the neighbor vector cluster with the shortest distance from the query vector according to the starting centroid block list and enabling the memory loading the posting list content, corresponding to the neighbor vector cluster, of the multiple posting list contents from the storage device, includes: enabling the memory loading the starting centroid block list, from the storage device, corresponding to the starting vector cluster in the RNG; adding the starting vector cluster in a priority queue in the memory; adding one or more centroid block list, corresponding to the one or more neighbor vector clusters, to a save queue in the memory according to the starting centroid block list, and removing the starting vector cluster from priority queue with labeling the starting vector cluster as checked; and obtaining the neighbor vector cluster with the shortest distance from the query vector according to the one or more centroid block list, corresponding to the one or more neighbor vector clusters, stored in the save queue, and enabling the memory loading the posting list content, from the storage device, corresponding to the neighbor vector cluster.

In certain configurations, the search instruction further includes a maximum size of a candidate list and a result size k, wherein k is an integer greater or equal to 1. By each time, when the processor obtains a neighbor vector cluster, with the shortest distance from the query vector, among a group of neighbor clusters, multiple full-precision vector contents, in the posting list content corresponding to the neighbor vector cluster, are added to the candidate list, until the nearest vector cluster, with the shortest distance from the query vector, in the RNG, being obtained, and adding multiple full-precision vector contents in the nearest posting list content corresponding to the nearest vector cluster. When the multiple full-precision vector contents in the candidate list is greater than the maximum size of the candidate list, redundant full-precision vector contents, including longer distance with the query vector are removed from the candidate list in the memory. The Processor uses k of the multiple full-precision vector contents, with the shortest distance from the query vector, in the candidate list as the query result, according to the result size k.

By the techniques provided by implementations according to the present disclosure, vector search algorithms can be improved, such as SPTAG algorithm, to minimum the memory usage. By storing data corresponding to tree index in the storage device, the memory usage can be decreased during vector search. By adjusting required data loaded by the memory during different read stages, latency can be reduced and search accuracy can be maintained, while reducing memory usage.

Example fast memory technologies applicable to memory as disclosed herein include floating-gate, split-gate, SONOS, floating dot, DRAM, DRAM-like (e.g., 2T0C), FeFET, and any memory technology compatible with search via word lines and bit lines. Exemplary SONOS memory technology (sometimes referred to as charge trap memory) uses an insulating layer (e.g., of silicon nitride) with traps to capture and retain charge as injected from a channel. Exemplary floating dot memory technology conceptually replaces a floating gate with a floating silicon nanodot or embeds floating silicon nanodots in a polysilicon gate. Exemplary 2T0C memory technology uses parasitic capacitance of a read transistor to store charge rather than an explicit storage capacitor. Exemplary FeFET memory technology uses permanent electrical field polarization of ferroelectric material embedded between a gate and a source-gate conduction region to store information.

It is understood that the foregoing disclosure presents implementations, variations, embodiments, and examples in an intended illustrative sense rather than in a limiting sense. It is contemplated that modifications and combinations are discernible that will be within the spirit of the disclosure and the scope of the following claims.

What is claimed is:

1. A computing device for approximate nearest neighbor search (ANNs), comprising:
a processor;
a memory, for loading a k-means tree index, wherein the k-means tree index comprises a plurality of levels, from a root level to a leaf level, and each of the plurality of levels comprises one or more nodes; and
a storage device, coupled to the processor and the memory, and configured to store one or more relative neighborhood graphs (RNGs) corresponding to the one or more nodes of the leaf level of the k-means tree index, and store a plurality of posting list contents of a plurality of vector clusters in each of the one or more RNGs,
wherein, when the processor executes the ANNs, the processor executes:
receiving a search instruction including a query vector;
obtaining a node, with the shortest distance from the query vector, among the one or more nodes of each of the plurality of levels, from the root level to the leaf level of the k-means tree, sequentially, until a result node in the leaf level is obtained;
enabling the memory loading a RNG, corresponding to the result node, of the one or more RNGs from the storage device;
obtaining a nearest vector cluster, from the plurality of vector clusters, with the shortest distance from the query vector;
enabling the memory loading a nearest posting list content, corresponding to the nearest vector cluster, of the plurality of posting list contents from the storage device; and
using a plurality of full-precision vector contents of the plurality of vectors in the nearest posting list content as a query result and outputting the query result.

2. The computing device of claim 1, wherein each of the one or more RNGs are stored in the storage device as forms of a plurality of centroid block lists, and each of the plurality of centroid block lists respectively includes a centroid vector ID corresponding to each of the plurality of vector clusters in each of the one or more RNGs, a centroid vector full-precision vector content, a respective one of the plurality of posting list contents, and a plurality of neighbor centroid vector IDs,
wherein the respective one of the plurality of posting list contents includes a posting list ID and a plurality of full-precision vector contents of a plurality of vectors included by one of the plurality of vector clusters corresponding to the respective one of the plurality of posting list contents, or includes the posting list ID of a posting list including the plurality of full-precision vector contents.

3. The computing device of claim 2, wherein the plurality of vectors included by each of the plurality of vector clusters of each of the one or more RNGs, are a centroid vector and a plurality of neighbor vectors, and the centroid vector is used for calculating the distance between the query vector and each of the plurality of vector clusters,
wherein the centroid vector of each of the plurality of vector clusters is related to a respective one of the plurality of centroid block lists.

4. The computing device of claim 3, wherein the plurality of vector clusters in each of the one or more RNGs includes a starting vector cluster, and one or more neighbor vector clusters couple to the starting vector cluster,
wherein the processor obtaining the nearest vector cluster, from the plurality of vector clusters, with the shortest distance from the query vector, comprises:
obtaining a neighbor vector cluster, with the shortest distance from the query vector, from the one or more neighbor vector clusters according to a starting centroid block list, corresponding to the starting vector cluster, of the plurality of centroid block lists;
enabling the memory loading a posting list content, corresponding to the neighbor vector cluster, of the plurality of posting list contents from the storage device; and
setting the neighbor vector cluster as the starting vector cluster and repeating the foresaid operations, until obtaining the nearest the nearest vector cluster, with the shortest distance from the query vector, in the RNG.

5. The computing device of claim 4, wherein the processor obtaining the neighbor vector cluster with the shortest distance from the query vector according to the starting centroid block list and enabling the memory loading the posting list content, corresponding to the neighbor vector cluster, of the plurality of posting list contents from the storage device, comprises:
enabling the memory loading the starting centroid block list, from the storage device, corresponding to the starting vector cluster in the RNG;
adding the starting vector cluster in a priority queue in the memory;
adding one or more centroid block list, corresponding to the one or more neighbor vector clusters, to a save queue in the memory according to the starting centroid block list, and removing the starting vector cluster from priority queue with labeling the starting vector cluster as checked; and
obtaining the neighbor vector cluster with the shortest distance from the query vector according to the one or more centroid block list, corresponding to the one or more neighbor vector clusters, stored in the save queue, and enabling the memory loading the posting list content, from the storage device, corresponding to the neighbor vector cluster.

6. The computing device of claim 5, wherein the search instruction further comprises a maximum size of a candidate list and a result size k, wherein k is an integer greater or equal to 1,
wherein, by each time, when the processor obtains a neighbor vector cluster, with the shortest distance from the query vector, among a group of neighbor clusters, a plurality of full-precision vector contents, in the posting list content corresponding to the neighbor vector cluster, are added to the candidate list, until the nearest vector cluster, with the shortest distance from the query vector in the RNG, being obtained, and adding a plurality of full-precision vector contents in the nearest posting list content corresponding to the nearest vector cluster,
wherein when the plurality of full-precision vector contents in the candidate list is greater than the maximum size of the candidate list, redundant full-precision vector contents, including longer distance with the query vector are removed from the candidate list in the memory,
wherein the processor uses k of the plurality of full-precision vector contents, with the shortest distance from the query vector, in the candidate list as the query result, according to the result size k.

7. An ANNs method, for a computing device including a processor, a memory and a storage device, the ANNs method comprising:
enabling, by the processor, the memory loading a k-means tree index, wherein the k-means tree index is corresponding to a plurality of vectors;
obtaining, by the processor, a node, with the shortest distance from a query vector, among one or more nodes of each of a plurality of levels, from a root level to a leaf level of the k-means tree, sequentially, until a result node in the leaf level is obtained;
enabling, by the processor, the memory loading a RNG, corresponding to the result node, of one or more RNGs storing in the storage device;
obtaining, by the processor, a nearest vector cluster, from a plurality of vector clusters, with the shortest distance from the query vector, and enabling the memory loading a nearest posting list content, corresponding to the nearest vector cluster, of a plurality of posting list contents storing in the storage device; and
using a plurality of full-precision vector contents of the plurality of vectors in the nearest posting list content as a query result and outputting the query result,
wherein the one or more RNGs are respectively corresponding to the one or more nodes in the leaf level, and the plurality of posting list contents are respectively corresponding to the plurality of vector clusters in each of the one or more RNGs.

8. The ANNs method of claim 7, wherein each of the one or more RNGs are stored in the storage device as forms of a plurality of centroid block lists, and each of the plurality of centroid block lists respectively includes a centroid vector ID corresponding to each of the plurality of vector clusters in each of the one or more RNGs, a centroid vector full-precision vector content, a respective one of the plurality of posting list contents, and a plurality of neighbor centroid vector IDs,
wherein the respective one of the plurality of posting list contents includes a posting list ID and a plurality of full-precision vector contents of a plurality of vectors included by one of the plurality of vector clusters corresponding to the respective one of the plurality of posting list contents, or includes the posting list ID of a posting list including the plurality of full-precision vector contents.

9. The ANNs method of claim 8, wherein the plurality of vectors included by each of the plurality of vector clusters of each of the one or more RNGs, are a centroid vector and a plurality of neighbor vectors, and the centroid vector is used for calculating the distance between the query vector and each of the plurality of vector clusters,
wherein the centroid vector of each of the plurality of vector clusters is related to a respective one of the plurality of centroid block lists.

10. The ANNs method of claim 9, wherein the plurality of vector clusters in each of the one or more RNGs includes a starting vector cluster, and one or more neighbor vector clusters couple to the starting vector cluster,
wherein the processor obtaining the nearest vector cluster, from the plurality of vector clusters, with the shortest distance from the query vector, comprises:
obtaining a neighbor vector cluster, with the shortest distance from the query vector, from the one or more neighbor vector clusters according to a starting centroid block list, corresponding to the starting vector cluster, of the plurality of centroid block lists;
enabling the memory loading a posting list content, corresponding to the neighbor vector cluster, of the plurality of posting list contents from the storage device; and
setting the neighbor vector cluster as the starting vector cluster and repeating the foresaid operations, until obtaining the nearest the nearest vector cluster, with the shortest distance from the query vector, in the RNG.

11. The ANNs method of claim 10, wherein the processor obtaining the neighbor vector cluster with the shortest distance from the query vector according to the starting centroid block list and enabling the memory loading the posting list content, corresponding to the neighbor vector cluster, of the plurality of posting list contents from the storage device, comprises:
enabling the memory loading the starting centroid block list, from the storage device, corresponding to the starting vector cluster in the RNG;
adding the starting vector cluster in a priority queue in the memory;
adding one or more centroid block list, corresponding to the one or more neighbor vector clusters, to a save queue in the memory according to the starting centroid block list, and removing the starting vector cluster from priority queue with labeling the starting vector cluster as checked; and
obtaining the neighbor vector cluster with the shortest distance from the query vector according to the one or more centroid block list, corresponding to the one or more neighbor vector clusters, stored in the save queue, and enabling the memory loading the posting list content, from the storage device, corresponding to the neighbor vector cluster.

12. The ANNs method of claim 11, wherein the search instruction further comprises a maximum size of a candidate list and a result size k, wherein k is an integer greater or equal to 1,
wherein, by each time, when the processor obtains a neighbor vector cluster, with the shortest distance from the query vector, among a group of neighbor clusters, a plurality of full-precision vector contents, in the posting list content corresponding to the neighbor vector cluster, are added to the candidate list, until the nearest vector cluster, with the shortest distance from the query vector in the RNG, being obtained, and adding a plurality of full-precision vector contents in the nearest posting list content corresponding to the nearest vector cluster,
wherein when the plurality of full-precision vector contents in the candidate list is greater than the maximum size of the candidate list, redundant full-precision vector contents, including longer distance with the query vector are removed from the candidate list in the memory,
wherein the processor uses k of the plurality of full-precision vector contents, with the shortest distance from the query vector, in the candidate list as the query result, according to the result size k.

13. A computing device for ANNs, comprising:
a processor, configured to process a plurality of vectors and generate a space partitioning data, the space partitioning data comprising:
a k-means tree index, corresponding to the plurality of vectors and including a plurality of levels, from a root level to a leaf level, wherein each of the plurality of levels comprises one or more nodes;
one or more RNGs, corresponding to the one or more nodes of the leaf level of the k-means tree, each of the one or more RNGs including a plurality of vector clusters; and
a plurality of posting list contents, corresponding to the plurality of vector clusters in each of the one or more RNGs;
a memory, configured to load the k-means tree; and
a storage device, configured to store the one or more RNGs and the plurality of posting list contents,
wherein, when the processor executes the ANNs, the processor executes:
receiving a search instruction including a query vector;
obtaining a node, with the shortest distance from the query vector, among the one or more nodes of each of the plurality of levels, from the root level to the leaf level of the k-means tree, sequentially, until a result node in the leaf level is obtained;
enabling the memory loading a RNG, corresponding to the result node, of the one or more RNGs from the storage device;
obtaining a nearest vector cluster, from the plurality of vector clusters, with the shortest distance from the query vector;
enabling the memory loading a nearest posting list content, corresponding to the nearest vector cluster, of the plurality of posting list contents from the storage device; and
using a plurality of full-precision vector contents of the plurality of vectors in the nearest posting list content as a query result and outputting the query result.

14. The computing device of claim 13, wherein each of the one or more RNGs are stored in the storage device as forms of a plurality of centroid block lists, and each of the plurality of centroid block lists respectively includes a centroid vector ID corresponding to each of the plurality of vector clusters in each of the one or more RNGs, a centroid vector full-precision vector content, a respective one of the plurality of posting list contents, and a plurality of neighbor centroid vector IDs,
wherein the respective one of the plurality of posting list contents includes a posting list ID and a plurality of full-precision vector contents of a plurality of vectors included by one of the plurality of vector clusters corresponding to the respective one of the plurality of posting list contents, or includes the posting list ID of a posting list including the plurality of full-precision vector contents.

15. The computing device of claim 14, wherein the plurality of vectors included by each of the plurality of vector clusters of each of the one or more RNGs, are a centroid vector and a plurality of neighbor vectors, and the centroid vector is used for calculating the distance between the query vector and each of the plurality of vector clusters,
wherein the centroid vector of each of the plurality of vector clusters is related to a respective one of the plurality of centroid block lists.

16. The computing device of claim 15, wherein the plurality of vector clusters in each of the one or more RNGs includes a starting vector cluster, and one or more neighbor vector clusters couple to the starting vector cluster,
wherein the processor obtaining the nearest vector cluster, from the plurality of vector clusters, with the shortest distance from the query vector, comprises:
obtaining a neighbor vector cluster, with the shortest distance from the query vector, from the one or more neighbor vector clusters according to a starting centroid block list, corresponding to the starting vector cluster, of the plurality of centroid block lists;
enabling the memory loading a posting list content, corresponding to the neighbor vector cluster, of the plurality of posting list contents from the storage device; and
setting the neighbor vector cluster as the starting vector cluster and repeating the foresaid operations, until obtaining the nearest the nearest vector cluster, with the shortest distance from the query vector, in the RNG.

17. The computing device of claim 16, wherein the processor obtaining the neighbor vector cluster with the shortest distance from the query vector according to the starting centroid block list and enabling the memory loading the posting list content, corresponding to the neighbor vector cluster, of the plurality of posting list contents from the storage device, comprises:
enabling the memory loading the starting centroid block list, from the storage device, corresponding to the starting vector cluster in the RNG;
adding the starting vector cluster in a priority queue in the memory;
adding one or more centroid block list, corresponding to the one or more neighbor vector clusters, to a save queue in the memory according to the starting centroid block list, and removing the starting vector cluster from priority queue with labeling the starting vector cluster as checked; and
obtaining the neighbor vector cluster with the shortest distance from the query vector according to the one or more centroid block list, corresponding to the one or more neighbor vector clusters, stored in the save queue, and enabling the memory loading the posting list content, from the storage device, corresponding to the neighbor vector cluster.

18. The computing device of claim 17, wherein the search instruction further comprises a maximum size of a candidate list and a result size k, wherein k is an integer greater or equal to 1,
wherein, by each time, when the processor obtains a neighbor vector cluster, with the shortest distance from the query vector, among a group of neighbor clusters, a plurality of full-precision vector contents, in the posting list content corresponding to the neighbor vector cluster, are added to the candidate list, until the nearest vector cluster, with the shortest distance from the query vector in the RNG, being obtained, and adding a plurality of full-precision vector contents in the nearest posting list content corresponding to the nearest vector cluster,
wherein when the plurality of full-precision vector contents in the candidate list is greater than the maximum size of the candidate list, redundant full-precision vector contents, including longer distance with the query vector are removed from the candidate list in the memory,
wherein the processor uses k of the plurality of full-precision vector contents, with the shortest distance from the query vector, in the candidate list as the query result, according to the result size k.
